(19) United States
(12) Patent Application Publication
(10) Pub. No.: US 2012/0327036 A1
(43) Pub. Date: Dec. 27, 2012

(54) LIGHT GUIDE ASSEMBLY AND OPTICAL TOUCH MODULE USING THE SAME

(75) Inventors: HUNG-CHING LAI, Hsinchu (TW); Hui-Hsuan Chen, Hsinchu (TW)

(73) Assignee: PixArt Imaging Inc., Hsinchu City (TW)

(21) Appl. No.: 13/523,833

(22) Filed: Jun. 14, 2012

(30) Foreign Application Priority Data
Jun. 22, 2011 (TW) 100211351
Dec. 1, 2011 (TW) 100144222

(51) Int. Cl. F21V 7/04; G06F 3/042

(52) U.S. Cl. 345/175; 362/609

(57) ABSTRACT

A light guide assembly includes a hollow mounting pillar and a light guide member. The hollow mounting pillar includes a plurality of sidewalls; a receiving groove is defined by the sidewalls and has an inlet. One of the sidewalls serves as a transparent portion and the rest of the sidewalls each serve as a reflection portion. The light guide member is disposed in the receiving groove, and a light incident surface of the light guide member is exposed from the inlet. The light guide assembly has advantages such as having a simpler production process and higher production efficiency. An optical touch module adopting the light guide assembly is also disclosed.

### TECHNICAL FIELD

The present invention relates to an optical touch module, and more particularly to a light guide assembly adopted in an optical touch module and an optical touch module using the same.

### BACKGROUND

Touch control module, due to have advantages such as an easy operation, in recent years has been widely used in many electronic products such as mobile phones, personal digital assistants (PDAs), digital cameras, music players, computers, satellite navigation devices, touch screens and so on. Today, the common touch control modules basically are categorized into the resistive touch modules, the capacitive touch modules and the optical touch modules. The optical touch modules, due to have some advantages such as a better durability and a low cost, have drawn more and more attentions.

The optical touch module must provide lights to a sensing area, so that the sensing element associated with the optical touch module can sense and determine the positions of the touch points. Conventionally, the guidance of lights to the sensing area is performed by a reflective strip or a light guide component.

FIG. 1A is a schematic three-dimensional (3D) structure view of a light guide assembly in a conventional optical touch module. FIG. 1B is a cross-sectional view of FIG. 1A along a line I-I. Please refer to FIGS. 1A, 1B. The light guide assembly 100 includes a light guide strip 110, a reflector 120 and a housing 130. The light guide strip 110 has a light incidence surface 112 and light emission surfaces 114a, 114b, 114c and 114d each arranged to be connected to the light incidence surface 112. The light emission surfaces 114b, 114c and 114d of the light guide strip 110 are wrapped by the reflector 120 and the light emission surface 114a, opposite to a sensing area of an optical touch apparatus (not shown), is arranged to be exposed from the reflector 120. Therefore, through reflections of the reflector 120, the lights emitted into the light guide strip 110 via the light incidence surface 112 can emit out from the light emission surface 114a. The housing 130 is arranged to wrap the reflector 120 and the light guide strip 110, and the lights emitted from the light emission surface 114a can emit through the housing 130.

However, in the conventional light guide assembly 100, the reflector 120 and the housing 130 each need to be manufactured individually and then assembled by a complicated assembling process; thus, the light guide assembly 100 may result in, due to need to be re-assembled if having inaccurate assembling positions, a low production efficiency.

### SUMMARY OF EMBODIMENTS

Therefore, one object of the present invention is to provide a light guide assembly having a simpler production process and higher production efficiency.

Another object of the present invention is to provide an optical touch module having a simpler production process and higher production efficiency.

The present invention provides a light guide assembly, which includes a hollow mounting pillar and a light guide member. The hollow mounting pillar includes a plurality of sidewalls; a receiving groove is defined by the sidewalls and has an inlet. One of the sidewalls serves as a transparent portion and the rest of the sidewalls each serve as a reflection portion. The light guide member is disposed in the receiving groove, and a light incident surface of the light guide member is exposed from the inlet.

In an embodiment of the present invention, the transparent portion contains light-filtering materials, and only a light with a specific waveband can emit through the light-filtering materials.

In an embodiment of the present invention, the reflection portion contains reflective materials.

In an embodiment of the present invention, the sidewalls of the hollow mounting pillar corporately have a one-piece structure.

In an embodiment of the present invention, the reflection portions include a first reflection portion, a second reflection opposite to the first reflection portion, and a third reflection portion arranged to be connected between the first and second reflection portions. The third reflection portion is arranged to be opposite to the transparent portion. The transparent portion is arranged to be connected between the first and third reflection portions.

In an embodiment of the present invention, the first and second reflection portions are arranged to be parallel to each other, the third reflection portion and the transparent portion are arranged to be perpendicular to the first reflection portion.

In an embodiment of the present invention, the hollow mounting pillar further includes an extension portion extending from the third reflection portion in a direction away from the receiving groove. The extension portion and the third reflection portion corporately form a fillister.

In an embodiment of the present invention, the hollow mounting pillar further includes an extension portion and at least a convex portion, the extension portion extends from the reflection portion opposite to the transparent portion in a direction away from the receiving groove, the extension portion and the reflection portion corporately form a fillister, the convex portion(s) is arranged to be connected to the extension portion and disposed at an opening of the fillister.

In an embodiment of the present invention, the extension portion includes a first plate and a second plate, the first plate is arranged to be connected to the reflection portion opposite to the transparent portion, the second plate is arranged to be connected to the first plate and opposite to the reflection portion opposite to the transparent portion, the convex portion(s) extends from the second plate to the reflection portion opposite to the reflection portion.

In an embodiment of the present invention, the extension portion includes a first plate and a second plate, the first plate and the second plate are arranged to be opposite to each other and connected to the reflection portion opposite to the transparent portion, the convex portion(s) includes a first convex portion and a second convex portion, the first convex portion extends in a direction from the first plate to the second plate, the second convex portion extends in a direction from the second plate to the first plate.

In an embodiment of the present invention, the transparent portion has a concentrator structure opposite to the receiving groove.

The present invention further provides an optical touch module with a sensing area, which includes at least a light guide assembly, at least a light source and at least a light sensing element. Each light guide assembly is disposed on an associated side of the sensing area. Each light source is configured to provide a light to a light incidence surface of the light guide member. Each light sensing element is disposed next to the sensing area.

In an embodiment of the present invention, the sidewalls of the hollow mounting pillar corporately have a one-piece structure.

In an embodiment of the present invention, the optical touch module further includes two wires disposed in the fillister, the convex portion(s) is configured to limit arrangement positions of the two wires, the two wires are arranged to be electrically connected to a positive end and a negative end of the light source, respectively.

The present invention still further provides a light guide assembly, which includes a hollow mounting pillar and a light guide member. The hollow mounting pillar includes a plurality of sidewalls; a receiving groove is defined by the sidewalls and has an inlet. One of the sidewalls serves as a transparent portion and the rest of the sidewalls each serve as a reflection portion. The hollow mounting pillar has a one-piece structure produced by a two-component injection molding technology. The reflection portions each have materials different with that of the transparent portion. The transparent portion contains light-filtering materials and only a light with a specific waveband can emit through the transparent materials. The light guide member is disposed in the receiving groove and a light incident surface thereof is exposed from the inlet.

In summary, in the present invention, the light guide member is disposed in the receiving groove which is defined by the sidewalls of the hollow mounting pillar of the light guide assembly, and the sidewalls of the hollow mounting pillar include the transparent portions and the reflection portions; thus, the light guide assembly according to the present invention, compared with the conventional light guide assembly having a number of components, can have light transparence and light reflection functions without a complicated structure. In addition, the hollow mounting pillar of the light guide assembly has, for example, a one-piece structure; and thus, the light guide assembly according to the present invention does not need a complicated assembly process so as to avoid the inaccurate assembly and the re-assembly. Therefore, the light guide assembly, as well as the optical touch assembly using the light guide assembly, according to the present invention can have higher production efficiency, and thereby reducing the costs of the optical touch assembly and the light guide assembly.

### BRIEF DESCRIPTION OF THE DRAWINGS

The above embodiments will become more readily apparent to those ordinarily skilled in the art after reviewing the following detailed description and accompanying drawings, in which:

FIG. 1A is a schematic three-dimensional structure view of a light guide assembly in a conventional optical touch module;

FIG. 1B is a cross-sectional view of FIG. 1A along a line I-I;

FIG. 2 is a schematic top view of an optical touch module in accordance with an embodiment of the present invention;

FIG. 3 is a cross-sectional view of FIG. 2 along a line II-II;

FIG. 4 is a schematic decomposition view of a light guide assembly adopted in the optical touch module of FIG. 2;

FIG. 5 is a schematic cross-sectional view of a light guide assembly in accordance with another embodiment of the present invention;

FIG. 6 is a schematic cross-sectional view of a light guide assembly in accordance with a further embodiment of the present invention;

FIG. 7 is a schematic view illustrating the relative positions of a light guide assembly, a light source and wires in accordance with still another embodiment of the present invention; and

FIG. 8 is a schematic view illustrating the relative positions of a light guide assembly, a light source and a conduction wire in accordance with still another embodiment of the present invention.

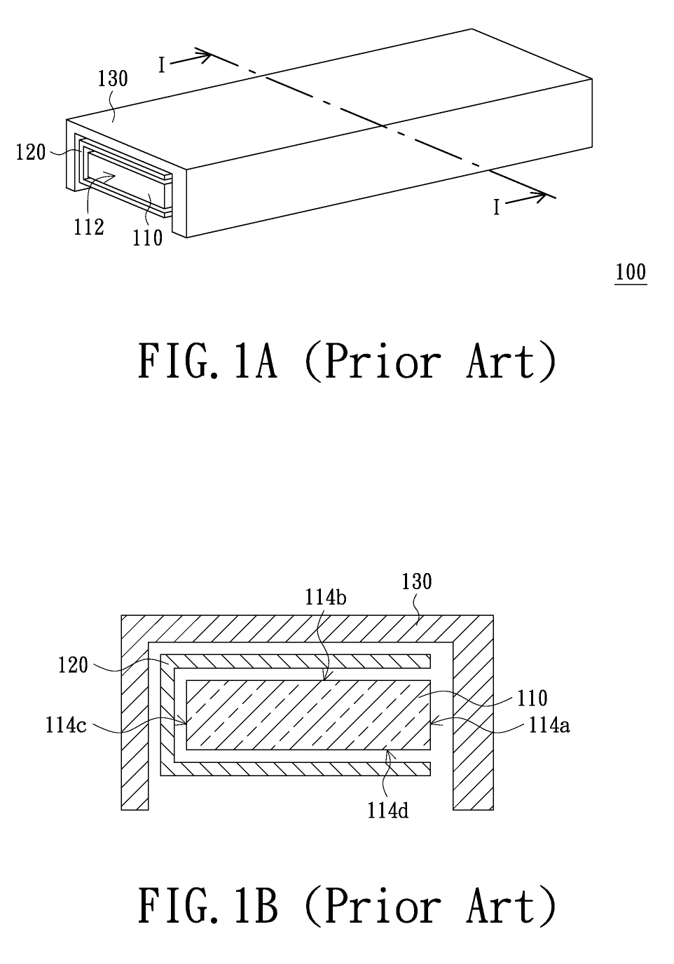

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

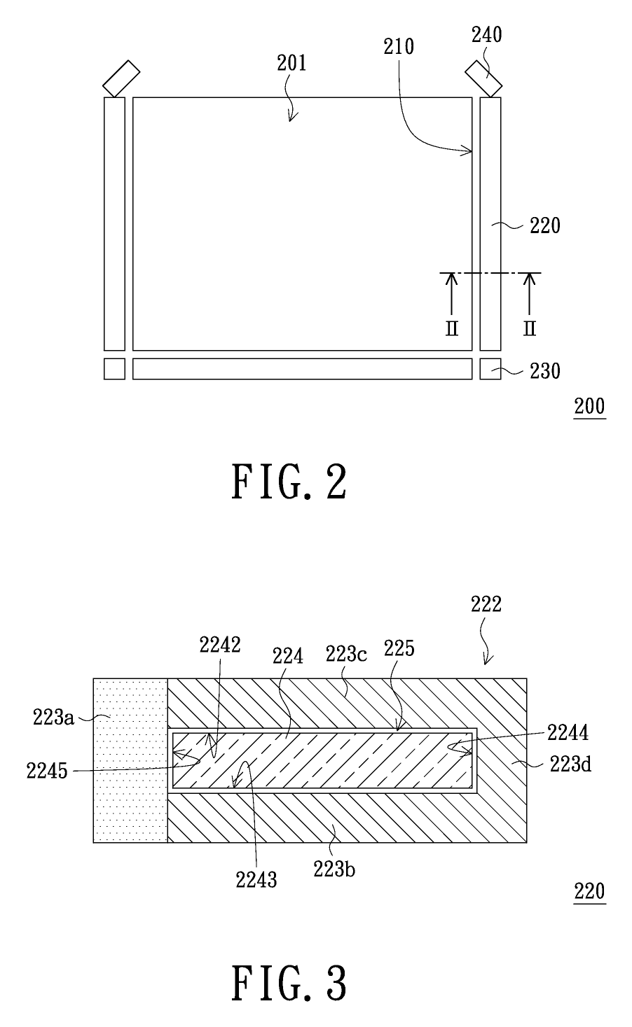

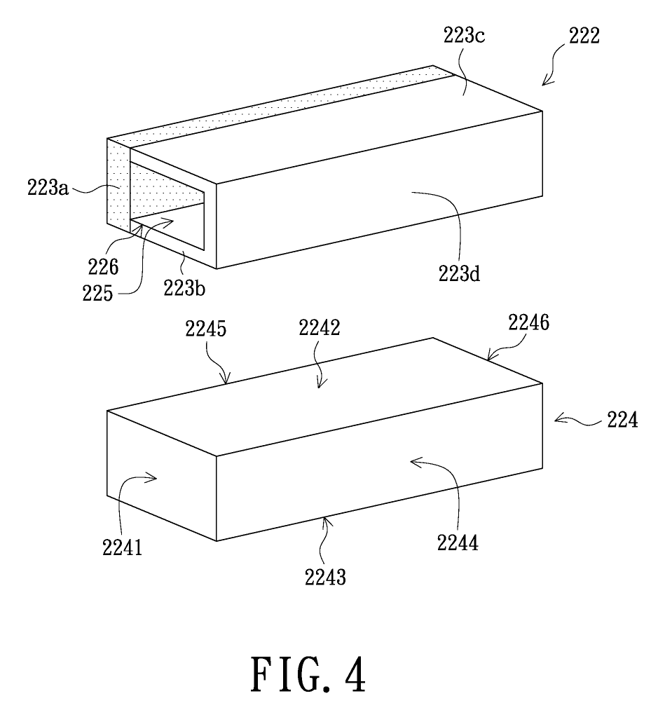

FIG. 2 is a schematic top view of an optical touch module in accordance with an embodiment of the present invention. FIG. 3 is a cross-sectional view of FIG. 2 along a line II-II. FIG. 4 is a schematic decomposition view of a light guide assembly adopted in the optical touch module of FIG. 2. Please refer to FIGS. 2, 3 and 4. The optical touch module 200 includes a sensing area 201, and the sensing area 201 includes a plurality of sidewalls 210. In the present embodiment, the sensing area 201 roughly has, without a limitation, a rectangular structure; and it is understood that the sensing area 201 may have other polygonal structures in other embodiments. The optical touch module 200 further includes a plurality of light guide assemblies 220, and each is disposed on a side of an associated sidewall 210 of the sensing area 201. In the present embodiment, it is to be noted that it is not necessary to arrange a light guide assembly 220 on a side of each sidewall 210 of the sensing area 201. In addition, the number of the light guide assemblies 220 can vary based on an actual need. In the present embodiment, there are, for example, three light guide assemblies 220, which are disposed on the sides of three sidewalls 210 of the sensing area 201, respectively. The optical touch module 200 further includes at least one light source 230 and at least one light sensing element 240; wherein the numbers and arrangement positions of the light source(s) 230 and light sensing element(s) 240 can vary based on an actual need. In the present embodiment, there are, for example, two light sources 230 and two light sensing elements 240. Specifically, each light source 230 is configured to provide lights to the associated light guide assemblies 220; each light guide assembly 220 is configured to guide the associated lights to the sensing area 201; and each light sensing element 240 is disposed on a side of the sensing area 201 and configured to sense the lights emitted from the associated light guide assembly 220.

Moreover, the light guide assembly 220 includes a hollow mounting pillar 222 and a light guide member 224. The hollow mounting pillar 222 includes a plurality of sidewalls. In the present embodiment, the hollow mounting pillar 222 includes, for example, four sidewalls 223a, 223b, 223c and 223d; and a receiving groove 225 is defined by these four sidewalls 223a, 223b, 223c and 223d. The receiving groove 225 is accommodative to the light guide member 224, so the light guide member 224 is capable of being disposed inside the receiving groove 225. In particular, the receiving groove 225 has an inlet 226 and through the inlet 226 the light guide member 224 can be disposed inside the receiving groove 225. It is to be noted that the number of the sidewalls is not limited in the present embodiment, and accordingly the shape of the receiving groove 225 varies with the number of the sidewalls. In addition, the receiving groove 225 includes only one inlet 226 in the present embodiment; however, the receiving groove 225 may include two inlets 226 disposed at the two opposite ends thereof in other embodiments.

One of the sidewalls 223a, 223b, 223c and 223d of the hollow mounting pillar 222 serves as a transparent portion, and the rest three each serve as a reflection portion. In particular, the sidewall 223a is, for example, a transparent portion and the sidewalls 223b, 223c and 223d each are, for example, a reflection portion; therefore, hereafter mark 223a is also designated as a transparent portion and marks 223b, 223c and 223d each are also designated as a reflection portion. It is to be noted that, in the present embodiment, the number of the sidewalls serving as a transparent portion is not limited to one and neither the number of the sidewalls serving as a reflection portion is limited; in particular, the number of the transparent portions and the number of the reflection portions can vary based on an actual need.

The transparent portion 223a is arranged to be opposite to the sensing area 201, and through the transparent portion 223a the lights provided by the light source 230 can be transmitted to the sensing area 201. The transparent portion 223a is made of transparent materials. In one embodiment, the transparent materials are light-filtering materials and only the lights with a specific waveband can emit through the light-filtering materials; so, the transparent portion 223a also serves as a light-filtering portion. The light sensing element 240 of the optical touch module 200 is configured to sense the aforementioned lights with a specific waveband. For example, the light-filtering materials can be selected from the materials capable of being emitted through by the infrared light and filtering the non-infrared light if the light sensing element 240 is configured to sense the infrared light and the light source 223a is configured to provide the infrared light. In addition, in order to increase the sensing accuracy of the light sensing element 240, the transparent materials of the transparent portion 223a can be selected from dark materials (for example, the black material).

The reflection portions 223b, 223c and 223d each are made of reflective materials. In the present embodiment, the reflection portions 223b, 223c are arranged to be opposite to each other; the reflection portion 223d is arranged to be connected between the reflection portions 223b, 223c; and the transparent portion 223a is arranged to be connected between the reflection portions 223b, 223c. In the present embodiment, without a limitation, the reflection portions 223b, 223c are arranged to be parallel to each other, and the reflection portion 223d and the transparent portion 223a are arranged to be perpendicular to the reflection portion 223b.

Moreover, the light guide member 224 has a light incidence surface 2241 and a plurality of light emission surfaces 2242, 2243, 2244 and 2245 which are arranged to be connected to the light incidence surface 2241. After the light guide member 224 is disposed inside the receiving groove 225 through the inlet 226, the light incidence surface 2241 of the light guide member 224 is exposed by the inlet 226. In the embodiment of the receiving groove 225 having two inlets 226 disposed at two ends thereof, the surface 2246 of the light guide member 224 opposite to the light incidence surface 2241 can also serve as another light incidence surface.

In the present embodiment, the light guide member 224 has, without a limitation, a rectangular prism. In a preferred embodiment, in order to avoid the assembly bias so the light guide member 224 can be fixed in the receiving groove 225 more accurately, the size of the receiving groove 225 is corresponding to that of the light guide member 224. In other words, the light guide member 224 in the receiving groove 225 are arranged to be attached on the sidewalls 223a, 223b, 223c and 223d of the hollow mounting pillar 222. In the present embodiment, the light emission surface 2242 is arranged to be opposite to the reflection portion 223c; the light emission surface 2243 is arranged to be opposite to the reflection portion 223b; the light emission surface 2244 is arranged to be opposite to the reflection portion 223d; and the light emission surface 2245 is arranged to be opposite to the transparent portion 223a. The lights emitted from the light source 230 emit into the light guide member 224 through the light incidence surface 2241 thereof, and emit out from the light guide member 224 through the light emission surfaces 2242, 2243, 2244 and 2245 thereof. A portion of lights emitted out from the light emission surfaces 2242, 2243 and 2244 are respectively reflected by the reflection portions 223b, 223c and 223d of the hollow mounting pillar 222; and thus, most of the lights provided by the light source 230 can be emitted out from the light emission surface 2245 and then further transmitted to the sensing area 201 through the transparent portion 223a of the hollow mounting pillar 222.

It is to be noted that, in the present embodiment, the sidewalls 223a, 223b, 223c and 223d of the hollow mounting pillar 222 of the light guide assembly 220 corporately have, for example, an one-piece structure, and the hollow mounting pillar 222 can be produced by the two-component injection molding technology; wherein the aforementioned two components contain the material for forming the reflection portions 223b, 223c and 223d and the material for forming the transparent portion 223a. Because the sidewalls 223a, 223b, 223c and 223d are fixed to each other once the hollow mounting pillar 222 is produced, there will be no any extra time for the assembling of the sidewalls 223a, 223b, 223c and 223d of the hollow mounting pillar 222. In other words, the present embodiment only needs to dispose the light guide member 224 inside the receiving groove 225 when the light guide assembly 220 is being assembled. And thus, the light guide assembly 220 according to the present embodiment does not need, compared with the conventional technologies, a complicated assembly process so as to avoid the inaccurate assembly and the re-assembly. Therefore, the light guide assembly 220, as well as the optical touch assembly 200 using the light guide assembly 220, according to the present embodiment can have higher production efficiency, and thereby reducing the costs of the optical touch assembly 200 and the light guide assembly 220.

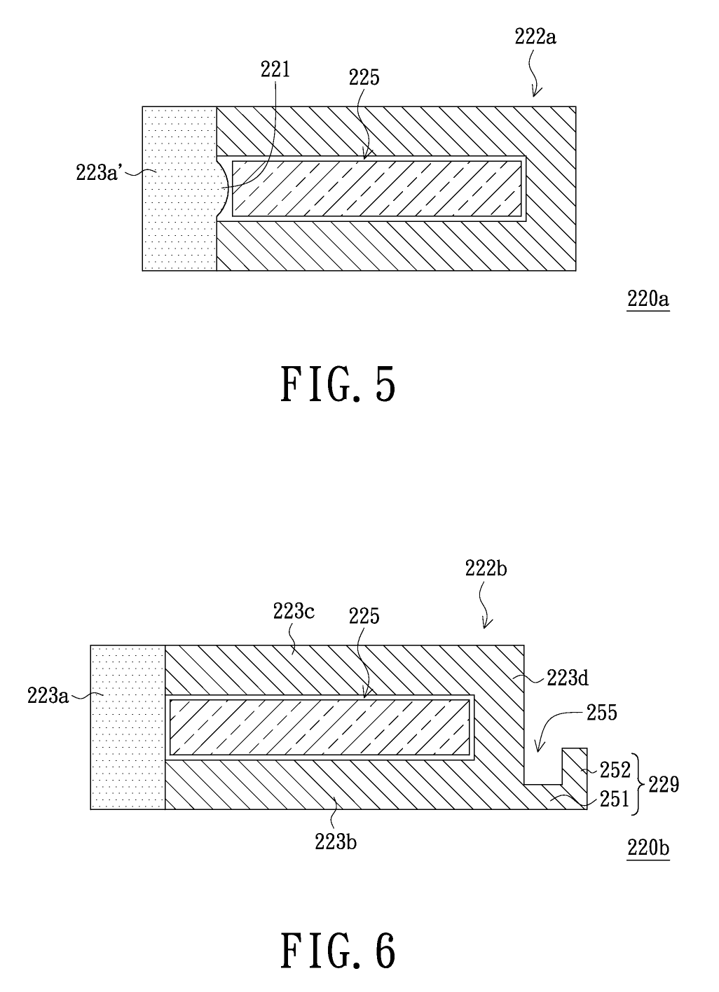

FIG. 5 is a schematic cross-sectional view of a light guide assembly in accordance with another embodiment of the present invention. As shown, the light guide assembly 220a according to the present embodiment is similar to the aforementioned light guide assembly 220, and the main difference between the two is that the transparent portion 223a′ of the hollow mounting pillar 222a has a concentrator structure 221, which is arranged to be, for example, opposite to the receiving groove 225 of the hollow mounting pillar 222a. The concentrator structure 221 is configured to provide a light-concentration effect so as to increase the light utilization ratio of an associated optical touch module which adopts the light guide assembly 220a.

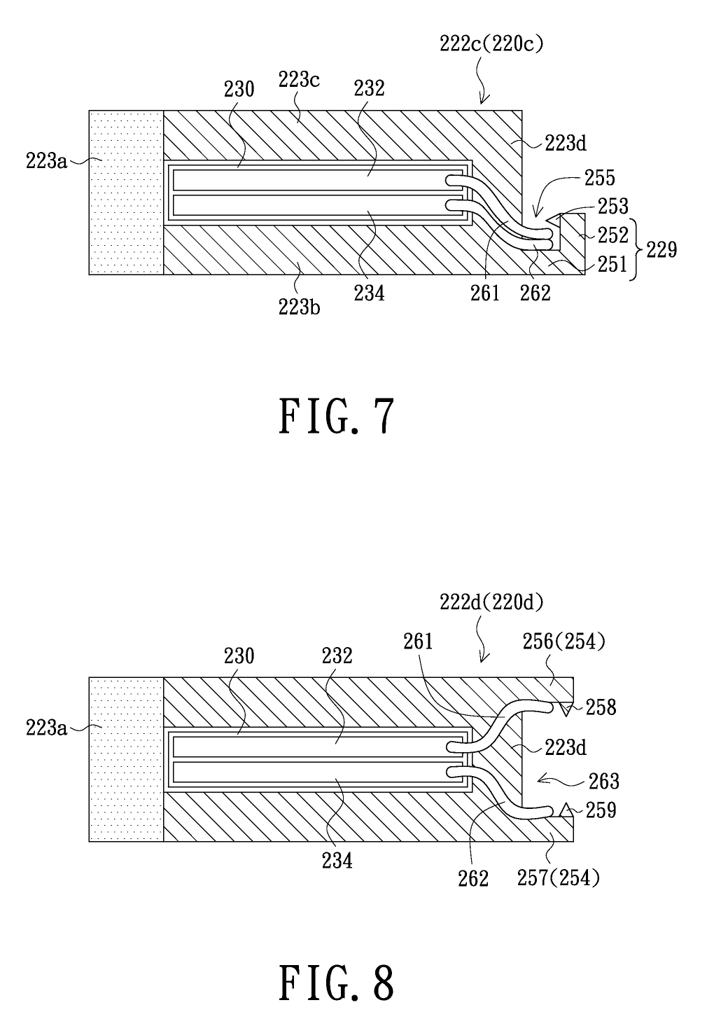

FIG. 6 is a schematic cross-sectional view of a light guide assembly in accordance with a further embodiment of the present invention. As shown, the light guide assembly 220b according to the present embodiment is similar to the aforementioned light guide assembly 220, and the main difference between the two is that the hollow mounting pillar 222b further includes an extension portion 229, which is arranged to extend, relative to the reflection portion 223d opposite to the transparent portion 223a, in a direction away from the receiving groove 225, and the extension portion 229 and the reflection portion 223d corporately form a fillister 255 for arranging wires of an associated optical touch module. The extension portion 229 includes, for example, a first plate 251 and a second plate 252. The first plate 251 is arranged to be connected to the reflection portion 223d, and the second plate 252 is arranged to be connected to the first plate 251 and opposite to the reflection portion 223d. The fillister 255 is formed between the first plate 251, the second plate 252 and the reflection portion 223d. In addition, this extension portion 229, the transparent portion 223a, the reflection portions 223b, 223c, and 223d corporately have, for example, an one-piece structure, so there will be no any extra time for the fixing of the extension portion 229 while the light guide assembly 220b is being assembled. FIG. 7 is a schematic view illustrating the relative positions of a light guide assembly, a light source and wires in accordance with still another embodiment of the present invention. As shown, the light guide assembly 220c according to the present embodiment is similar to the light guide assembly 220b in FIG. 6; the main difference between the two is that the hollow mounting pillar 222c further includes at least one convex portion 253; wherein FIG. 7 is exemplified by one convex portion 253. The convex portion 253 is arranged to be connected to the extension portion 229 and disposed at an opening of the fillister 255. Specifically, the convex portion 253 extends from one end (for example, the end far away from the first plate 251) of the second plate 252 and toward the reflection portion 223d.

In addition, as illustrated in FIG. 7, the light guide member of the light guide assembly 220c of the optical touch module is blocked by the light source 230 arranged next to itself, thus the light guide member is not shown in FIG. 7. The wires 261, 262 of the optical touch module are arranged to be electrically connected to the positive end 232 and the negative end 234 of the light source 230, respectively, and for transmitting the electrical power to the light source 230. The wires 261, 262 are arranged in the fillister 255. The convex portion 253 and the fillister 255 are configured to limit the arrangement positions of the wires 261, 262 in the fillister 255. In order to facilitate a simpler production process, the convex portion 253 can have a structure with a wider bottom and a narrower top, such as a triangular or a semi-cylindrical structure; however, it is to be noted that the present invention does not limit the shape of the convex portion 253. In addition, the extension portion 229, the convex portion 253 and the sidewalls 223a, 223b, 223c, and 223d of the hollow mounting pillar 222c corporately have a one-piece structure.

FIG. 8 is a schematic view illustrating the relative positions of a light guide assembly, a light source and a conduction wire in accordance with still another embodiment of the present invention. As shown, the light guide assembly 220d according to the present embodiment is similar to the light guide assembly 220c in FIG. 7, and the main difference between the two is related to the extension portion. In the present embodiment, the extension portion 254 of the hollow mounting pillar 222d includes a first plate 256 and a second plate 257, which are arranged to be opposite to each other and connected to the reflection portion 223d opposite to the transparent portion 223a. The first plate 256, the second plate 257 and the reflection portion 223d corporately forms a fillister 263. In addition, the hollow mounting pillar 222d, for example, further includes two convex portions 258, 259 disposed at an opening of the fillister 263. The convex portion 258 extends in a direction from the first plate 256 toward the second plate 257; and the convex portion 259 extends in a direction from the second plate 257 toward the first plate 256. The convex portions 258, 259 each have a structure similar to that of the aforementioned convex portion 253; thus, there is no any unnecessary detail will be given herein.

Similarly, the light guide member of the light guide assembly 220d is blocked by the light source 230 arranged next to itself; thus, the light guide member is not shown in FIG. 8. The wires 261, 262 are arranged in the fillister 263; wherein the wire 261 is limited in a space formed by the first plate 256, the convex portion 258 and the reflection portion 223d; and the wire 262 is limited in a space formed by the second plate 257, the convex portion 259 and the reflection portion 223d. The wires 261, 262 are arranged to be electrically connected to the positive end 232 and the negative end 234 of the light source 230, respectively.

It is to be noted that, the light guide assembly 220 in the optical touch module 200 can be replaced by the light guide assemblies 220a, 220b, 220c and 220d each. In addition, the transparent portion 223a of the light guide assemblies 220b, 220c and 220d may also have the concentrator structure 221 shown in FIG. 5.

In summary, in the present invention, the light guide member is disposed in the receiving groove which is defined by the sidewalls of the hollow mounting pillar of the light guide assembly, and the sidewalls of the hollow mounting pillar include the transparent portions and the reflection portions; thus, the light guide assembly according to the present invention, compared with the conventional light guide assembly having a number of components, can have light transparence and light reflection functions without a complicated structure. In addition, the hollow mounting pillar of the light guide assembly has, for example, a one-piece structure; and thus, the light guide assembly according to the present invention does not need a complicated assembly process so as to avoid the inaccurate assembly and the re-assembly. Therefore, the light guide assembly, as well as the optical touch assembly using the light guide assembly, according to the present invention can have higher production efficiency, and thereby reducing the costs of the optical touch assembly and the light guide assembly.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light guide assembly, comprising:
a hollow mounting pillar comprising a plurality of sidewalls, a receiving groove being defined by the sidewalls and having an inlet, one of the sidewalls serving as a transparent portion and the rest of the sidewalls each serving as a reflection portion; and
a light guide member disposed in the receiving groove, and a light incident surface of the light guide member being exposed from the inlet.

2. The light guide assembly according to claim 1, wherein the transparent portion contains light-filtering materials, and only a light with a specific waveband can emit through the light-filtering materials.

3. The light guide assembly according to claim 1, wherein the reflection portion contains reflective materials.

4. The light guide assembly according to claim 1, wherein the sidewalls of the hollow mounting pillar corporately have a one-piece structure.

5. The light guide assembly according to claim 1, wherein the reflection portions comprise a first reflection portion, a second reflection opposite to the first reflection portion, and a third reflection portion arranged to be connected between the first and second reflection portions, the third reflection portion is arranged to be opposite to the transparent portion, and the transparent portion is arranged to be connected between the first and third reflection portions.

6. The light guide assembly according to claim 5, wherein the first and second reflection portions are arranged to be parallel to each other, the third reflection portion and the transparent portion are arranged to be perpendicular to the first reflection portion.

7. The light guide assembly according to claim 5, wherein the hollow mounting pillar further comprises an extension portion extending from the third reflection portion in a direction away from the receiving groove, the extension portion and the third reflection portion corporately form a fillister.

8. The light guide assembly according to claim 1, wherein the hollow mounting pillar further comprises an extension portion and at least a convex portion, the extension portion extends from the reflection portion opposite to the transparent portion in a direction away from the receiving groove, the extension portion and the reflection portion corporately form a fillister, the convex portion(s) is arranged to be connected to the extension portion and disposed at an opening of the fillister.

9. The light guide assembly according to claim 8, wherein the extension portion comprises a first plate and a second plate, the first plate is arranged to be connected to the reflection portion opposite to the transparent portion, the second plate is arranged to be connected to the first plate and opposite to the reflection portion opposite to the transparent portion, the convex portion(s) extends from the second plate to the reflection portion opposite to the reflection portion.

10. The light guide assembly according to claim 8, wherein the extension portion comprises a first plate and a second plate, the first plate and the second plate are arranged to be opposite to each other and connected to the reflection portion opposite to the transparent portion, the convex portion(s) comprises a first convex portion and a second convex portion, the first convex portion extends in a direction from the first plate to the second plate, the second convex portion extends in a direction from the second plate to the first plate.

11. The light guide assembly according to claim 1, wherein the transparent portion has a concentrator structure opposite to the receiving groove.

12. An optical touch module with a sensing area, comprising:
at least a light guide assembly, each light guide assembly being disposed on an associated side of the sensing area, each light guide assembly comprising:
a hollow mounting pillar comprising a plurality of sidewalls, a receiving groove being defined by the sidewalls, the receiving groove comprising an inlet, one of the sidewalls serving as a transparent portion and another one of the sidewalls serving as a reflection portion, the transparent portion being arranged to be next to the sensing area; and
a light guide member disposed in the receiving groove, a light incidence surface of the light guide member being exposed by the inlet;
at least a light source configured to provide a light to the light incidence surface of the light guide member; and
at least a light sensing element disposed next to the sensing area.

13. The optical touch module according to claim 12, wherein the sidewalls of the hollow mounting pillar corporately have a one-piece structure.

14. The optical touch module according to claim 12, wherein the hollow mounting pillar further comprises an extension portion and at least a convex portion, the extension portion extends from the reflection portion in a direction away from the receiving groove, the extension portion and the reflection portion opposite to the transparent portion corporately form a fillister, the convex portion(s) is arranged to be connected to the extension portion and disposed at an opening of the fillister.

15. The optical touch module according to claim 14, wherein the extension portion comprises a first plate and a second plate, the first plate is arranged to be connected to the reflection portion opposite to the transparent portion, the second plate is arranged to be connected to the first plate and opposite to the reflection portion opposite to the transparent portion, the convex portion(s) extends from the second plate to the reflection portion opposite to the reflection portion.

16. The optical touch module according to claim 14, wherein the extension portion comprises a first plate and a second plate, the first plate and the second plate are arranged to be opposite to each other and connected to the reflection portion opposite to the transparent portion, the convex portion(s) comprises a first convex portion and a second convex portion, the first convex portion extends in a direction from the first plate to the second plate, the second convex portion extends in a direction from the second plate to the first plate.

17. The optical touch module according to claim 14, further comprising two wires disposed in the fillister, the convex portion(s) is configured to limit arrangement positions of the two wires, the two wires are arranged to be electrically connected to a positive end and a negative end of the light source, respectively.

18. A light guide assembly, comprising:
a hollow mounting pillar comprising a plurality of sidewalls, a receiving groove being defined by the sidewalls and having an inlet, one of the sidewalls serving as a transparent portion and another one of the sidewalls serving as a reflection portion, the hollow mounting pillar having an one-piece structure produced by a two-component injection molding technology, the reflection portions having materials different with that of the transparent portion, the transparent portion containing light-filtering materials and only a light with a specific waveband can emit through the transparent materials; and
a light guide member disposed in the receiving groove and a light incident surface thereof being exposed from the inlet.

19. The light guide assembly according to claim 18, wherein the light-filtering materials are capable of being emitted through by an infrared light.

20. The light guide assembly according to claim 18, wherein the reflection portions each contains reflective materials.
